(19) United States
(12) Patent Application Publication
(10) Pub. No.: US 2025/0093113 A1
(43) Pub. Date: Mar. 20, 2025

(54) MULTI-MATERIAL PRINTED HEAT EXCHANGER PRODUCED BY DIFFUSION BONDING

(71) Applicant: Westinghouse Electric Company LLC, Cranberry Township, PA (US)

(72) Inventors: Cory A. STANSBURY, Gorham, ME (US); Michael R. ICKES, West Homestead, PA (US)

(73) Assignee: Westinghouse Electric Company LLC, Cranberry Township, PA (US)

(21) Appl. No.: 18/467,395

(22) Filed: Sep. 14, 2023

(51) Int. Cl. F28F 3/08; F28D 21/00

(52) U.S. Cl. CPC F28F 3/08; F28D 2021/0054; F28F 2275/061

(57) ABSTRACT

A heat exchanger for a nuclear reactor is provided. The heat exchanger comprises a first layer for flowing a first process fluid and a second layer for flowing a second process fluid. The first layer is comprised of a first material and the second layer is comprised of a second material differing in composition from the first material. The first layer and the second layer are stacked on each other in a core of the heat exchanger and the first layer and the second layer are bonded to each other. A heat exchanger for a nuclear reactor and a method for producing a heat exchanger are also provided.

### BACKGROUND

Nuclear reactors generally employ a coolant to extract heat generated by nuclear fuel. The coolant then flows through primary channels in a heat exchanger to transfer heat to a secondary fluid flowing through secondary channels of the heat exchanger. In some nuclear reactors, such as fast reactors utilizing a pressurized secondary fluid, the heat exchanger is generally manufactured from codified materials which are approved for use as pressure boundaries. However, incompatibilities between coolants and currently codified materials can compromise the structural integrity of the heat exchanger during reactor operation. Accordingly, there exists a need for alternative heat exchangers and manufacturing methods thereof for nuclear reactors, such as, for example, fast reactors. The present disclosure provides various solutions that employ multiple materials for addressing incompatibilities between process fluids and heat exchanger materials.

### SUMMARY

The following summary is provided to facilitate an understanding of some of the innovative features unique to the aspects disclosed herein and is not intended to be a full description. A full appreciation of the various aspects disclosed herein can be gained by taking the entire specification, claims, and abstract as a whole.

In various aspects, a heat exchanger for a nuclear reactor is disclosed. In some aspects, the heat exchanger includes a first layer for flowing a first process fluid and a second layer for flowing a second process fluid. In some aspects, the first layer includes a first sheet and a first formed plate defining a number of first flow channels therebetween. In some aspects, the first layer is comprised of a first material. In some aspects, the second layer includes a second sheet and a second formed plate defining a number of second flow channels therebetween. In some aspects, the second layer is comprised of a second material differing in composition from the first material. In some aspects, the first layer and the second layer are stacked on each other in a core of the heat exchanger and the first layer and the second layer are bonded to each other.

In various aspects, a heat exchanger for a nuclear reactor is disclosed. In some aspects, the heat exchanger includes a core. In some aspects, the core includes first layers for flowing a lead based fluid and second layers for flowing a supercritical fluid. In some aspects, each of the first layers includes a first sheet and a first formed plate defining a number of first flow channels therebetween, and each of the second layers includes a second sheet and a second formed plate defining a number of second flow channels therebetween. In some aspects, each of the first layers is comprised of a first material configured to be compatible with the lead based fluid, and each of the second layers is comprised of a second material incompatible with the lead based fluid. In some aspects, the first layers and the second layers are stacked in an alternating arrangement, and the stacked first layers and second layers are diffusion bonded to one another.

In various aspects, a method for producing a heat exchanger is disclosed. In some aspects, the method includes providing a number of first layers and second layers, stacking each of the provided first layers and second layers in an alternating order and diffusion bonding the stacked layers together to form a core of the heat exchanger. In some aspects, the providing includes arranging a first flat sheet and a first formed plate to provide a first layer, and arranging a second flat sheet and a second formed plate to provide a second layer. In some aspects, the first formed plate and the first flat sheet define a number of first flow channels therebetween and the second formed plate and the second flat sheet define a number of second channels therebetween. In some aspects, the first flat sheet and the first formed plate are comprised of a first composition, and the second flat sheet and the second formed plate are comprised of a second composition.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of any of the aspects disclosed herein.

### BRIEF DESCRIPTION OF THE DRAWINGS

The various aspects described herein, together with objects and advantages thereof, may best be understood by reference to the following description, taken in conjunction with the accompanying drawings as follows.

FIG. 1 is a cross-sectional schematic representation of a heat exchanger, in accordance with at least one non-limiting aspect of the present disclosure.

FIG. 2 is a cross-sectional schematic representation of a heat exchanger, in accordance with at least one non-limiting aspect of the present disclosure.

FIG. 3 is a cross-sectional schematic representation of a heat exchanger, in accordance with at least one non-limiting aspect of the present disclosure.

FIG. 4 is a cross-sectional schematic representation of a heat exchanger, in accordance with at least one non-limiting aspect of the present disclosure.

FIG. 5 is a block diagram illustrating a method for producing a heat exchanger, in accordance with at least one non-limiting aspect of the present disclosure.

Corresponding reference characters indicate corresponding parts throughout the several views. The exemplifications set out herein illustrate various aspects of the present disclosure, in one form, and such exemplifications are not to be construed as limiting the scope of any of the aspects disclosed herein.

### DETAILED DESCRIPTION

Certain exemplary aspects of the present disclosure will now be described to provide an overall understanding of the principles of the composition, function, manufacture, and use of the compositions and methods disclosed herein. An example or examples of these aspects are illustrated in the accompanying drawing. Those of ordinary skill in the art will understand that the compositions, articles, and methods specifically described herein and illustrated in the accompanying drawing are non-limiting exemplary aspects and that the scope of the various examples of the present disclosure is defined solely by the claims. The features illustrated or described in connection with one exemplary aspect may be combined with the features of other aspects. Such modifications and variations are intended to be included within the scope of the present disclosure.

Reference throughout the specification to “various examples,” “some examples,” “one example,” “an example,” or the like, means that a particular feature, structure, or characteristic described in connection with the example is included in an example. Thus, appearances of the phrases “in various examples,” “in some examples,” “in one example,” “in an example,” or the like, in places throughout the specification are not necessarily all referring to the same example. Furthermore, the particular features, structures, or characteristics may be combined in any suitable manner in an example or examples. Thus, the particular features, structures, or characteristics illustrated or described in connection with one example may be combined, in whole or in part, with the features, structures, or characteristics of another example or other examples without limitation. Such modifications and variations are intended to be included within the scope of the present examples.

In the following description, like reference characters designate like or corresponding parts throughout the several views of the drawings. Also in the following description, it is to be understood that such terms as “forward,” “rearward,” “left,” “right,” “above,” “below,” “upwardly,” “downwardly,” and the like are words of convenience and are not to be construed as limiting terms.

Nuclear reactors generally employ a coolant to extract heat generated by nuclear fuel. The coolant then flows through primary channels in a heat exchanger (sometimes referred to as “HX”) to transfer heat to a secondary fluid flowing through secondary channels of the heat exchanger. The type of coolant may vary depending on reactor type. For example, many thermal neutron reactors may employ light or heavy water as a coolant at various operating pressures. In contrast, fast reactors may necessitate the use of alternative coolants due to the neutron moderating properties of water. For example, fast reactors may employ liquid and/or molten metals such as a molten lead-based coolant in a Lead Fast Reactor (“LFR”). Other fast reactors may employ liquid sodium, molten salts, or gaseous coolants. However, water may still be employed as the secondary heat transfer fluid.

Normal operating temperatures in a fast reactor must stay within the liquid region of the phase diagram of the employed coolant to avoid overpressurizing the reactor core, which would increase the probability of an accident, and to stay within favorable heat transfer regimes. However, meeting this condition is generally not of any concern. For example, LFRs generally operate at a temperature between about 500° C. to about 700° C. while lead has a melting point of about 327° C. and a boiling point of about 1749° C. In the secondary side of the heat exchanger, water may be at or above its critical point due to the secondary design pressure and operating temperature of the core. Therefore, heat exchangers intended for LFRs and other fast reactors may incorporate high strength ASME-qualified materials, such as a 300 series austenitic stainless steel, and designs which can accommodate both high temperatures and pressures while providing a margin of safety. In some aspects, design parameters for these heat exchangers may call for temperatures and pressure of about 650° C. and 38 megapascals (MPa) to provide the necessary structural integrity to reduce the likelihood of pressurizing the reactor vessel via ingress of supercritical water into molten lead.

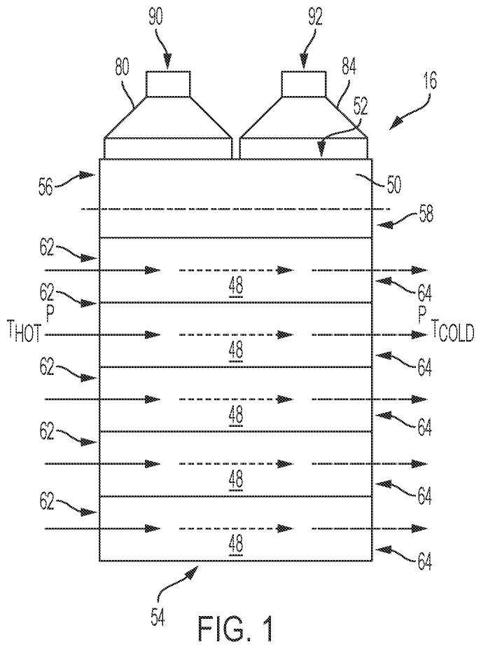

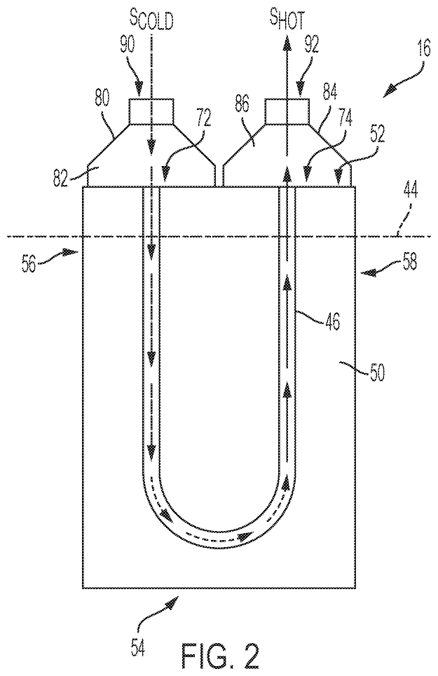

In the context of fast reactors, modern HX designs, such as printed circuit heat exchangers (PCHEs), can be implemented to provide higher heat transfer areas with reduced volumes relative to conventional shell and tube designs. For example, FIGS. 1-2 illustrate a schematic cross-sectional representation of a PCHE 16, in accordance with at least one non-limiting embodiment of the present disclosure. FIG. 1 illustrates a schematic representation of the flow of primary coolant P and FIG. 2 illustrates a schematic representation of the flow of secondary fluid S. PCHE 16 includes a core 50 formed from a stack of plates diffusion bonded together. As shown in FIG. 1, PCHE 16 includes a plurality of horizontal primary channels 48 defined in the core 50. Each of the primary channels 48 extend from a primary inlet 62 to a primary outlet 64 defined in the second side face 58. As illustrated in FIG. 2, PCHE 16 further includes secondary channels 46 (only one is shown in the illustrated example) defined in the core 50, each of the secondary channels 46 extends among at least some of the primary channels 48 from a vertically oriented secondary inlet 72 to a vertically oriented secondary outlet 74. Alternatively, the illustrated flow direction between the secondary inlet 72 and outlet 74 may be reversed in a counterflow configuration. PCHE 16 further includes an inlet plenum 80 which defines a first space 82 therein which is in fluid communication with the secondary inlets 72; and an outlet plenum 84 which defines a second space 86 therein which is in fluid communication with the secondary outlets 74. The inlet plenum 80 includes a main inlet 90 which is structured to be fluidly coupled to a supply header, and the outlet plenum 84 includes a main outlet 92 which is structured to be fluidly coupled to a return header. Additional details are described in U.S. patent application Ser. No. 16/149,595, entitled POOL TYPE LIQUID METAL FAST SPECTRUM REACTOR USING A PRINTED CIRCUIT HEAT EXCHANGER CONNECTION TO THE POWER CONVERSION SYSTEM, filed Oct. 2, 2018, which issued on Oct. 12, 2021 as U.S. Pat. No. 11,145,422, which is hereby incorporated by reference herein in its entirety.

When used to produce heat exchangers, diffusion bonding can provide advantages over traditional joining methods which require a clear line of sight of surfaces and/or bodies to be joined. For example, traditional fusion welding relies on imparting a source of heat and/or energy concentrated at a designated interface to form a joint, which is time intensive and subject to introducing residual stresses at the joints. In contrast, diffusion bonding applies high pressure to metals at elevated temperatures below the melting temperature of the metals which does not result in any substantial plastic deformations and/or residual stresses in the joined metals. Grain boundaries in components of a diffusion bonded structure are grown together to form a continuous, monolithic structure. Accordingly, diffusion bonding can provide robust boundaries between intricate and/or small (i.e. millimeter scale) primary and/or secondary channels, thereby reducing the likelihood of ruptures. However, currently available ASME-compliant materials may be incompatible with certain working fluids. For example, at temperatures of about 480° C. or greater, lead-based coolants can become corrosive to austenitic stainless steels, thereby weakening the pressure boundary and/or any pressure-bearing region. Additionally, as the heat exchanger is exposed to high temperatures for extended periods of time, the pressure boundaries therein may further undergo creep. Therefore, the combination of corrosion and creep deformation can cause the heat exchanger to rupture in high pressure differential regions. Accordingly, various aspects of the present disclosure provide various devices and methods that optimize the performance and reliability of PCHEs. In some implementations, the optimization can avoid technical and/or logistical issues associated with heat exchanger materials used in PCHEs and the compatibility thereof with process fluids.

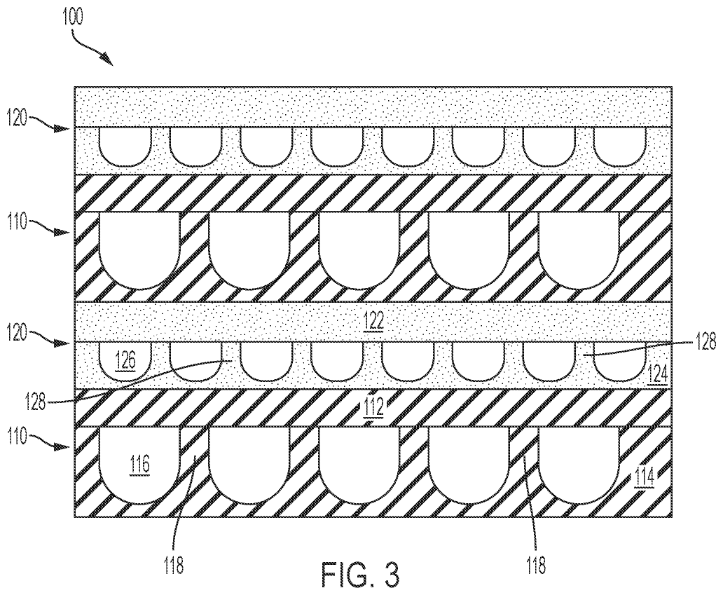

Now referring to FIG. 3, a schematic representation of a heat exchanger 100 is provided according to at least one non-limiting embodiment of the present disclosure. The heat exchanger 100 includes a first layer 110 configured to flow a first process fluid and a second layer 120 configured to flow a second process fluid. The first process fluid may include a liquid metal, an ionic liquid, a molten metal, a molten salt, or any combination thereof. In some aspects, the first process fluid is molten lead. The second process fluid may be a pressurized fluid, such as water.

The first layer 110 includes a sheet 112 and a plate 114. In various aspects, the plate 114 includes a number of first open face channels 116 formed therein such that a joining of the sheet 112 on top of the plate 114 will form closed flow channels through which a first fluid may flow through. The open channels 116 may be formed as a result of etching, rolling, stamping, coining, and/or extruding the formed plates 114.

The first layer 110 can be configured to flow a first process fluid at ambient pressure conditions. In some aspects, the cross sectional area of the channels 116 can be sized to flow molten lead therethrough without a substantial pressure drop to maintain an optimal flow velocity thereof. In certain aspects, the channels 116 may be sized for pressure drops of about 50 kilopascals (kPa) or less, or about 17 kPa. For example, plates 114 having a thickness of about, or slightly greater than, 5 mm can include channels 116 having a cross-sectional area of about 16 mm² separated by intermediate sections 118 having a thickness of about 1 mm or less, or about 0.4 mm. Although the channels 116 are illustrated in FIG. 3 as having a U-shape cross-section geometry, other embodiments are contemplated by the present disclosure. For example, in some implementations, the channels 116 may have a rectangular, square, circular, semi-circular, triangular, trapezoidal or hexagonal cross-section geometry.

Further to the above, the second layer 120 includes a sheet 122 and a formed plate 124 defining a number of second flow channels therebetween. For example, the plate 124 may have a number of second open face channels 126 formed therein such that a second fluid may flow therethrough upon joining the sheet 122 and the formed plate 124 together. The formed plate 124 may be formed from sheetstock. The open channels 126 may be formed as a result of etching, rolling, stamping, coining, and/or extruding the formed plates 124. In other examples, the open channels 126 are formed during the forming of a plate 124. In some examples, the sheet has a thickness of about 1 millimeter or less.

The second layer 120 can be configured as a pressure boundary to flow a second process fluid, such as water, at pressurized conditions and/or near-critical or supercritical conditions. In some aspects, the cross sectional area of the channels 126 can be sized to flow supercritical water therethrough without a substantial pressure drop to maintain an optimal flow velocity thereof. In certain aspects, the channels 126 may be sized for pressure drops of less than 1000 kPa, or about 590 kPa. For example, plates 124 having an overall thickness of about 1.5 mm can include channels 126 having a cross-sectional area of about 1 square millimeters (mm²) or less separated by intermediate sections 128 having a thickness of about 1 mm. Although the channels 116 are illustrated in FIG. 3 as having a U-shape cross-section geometry, other embodiments are contemplated by the present disclosure. For example, in some implementations, the channels 116 may have a rectangular, square, circular, semi-circular, triangular, trapezoidal or hexagonal cross-section geometry.

In various aspects, the layers 110 and 120 of the heat exchanger 100 are stacked prior to a diffusion bonding to one another. In other words, the layers 110 and 120 form a core of a PCHE. As illustrated in FIG. 3, the layers 110 and 120 are arranged in an alternating stacked fashion such that channels of adjacent layers are separated by the thickness of a single sheet and a portion of the thickness of a plate. Additionally, or alternatively, the plates and sheets of each of the layers 110 and/or 120 themselves may be diffusion bonded such that each diffusion bonded layer may be inspected and/or pressure tested prior to being stacked on one another. In some aspects, this arrangement of diffusion bonded layers can simplify manufacturing of the heat exchangers 100 while maintaining a low defect rate thereof. Thus, in some aspects, the arrangement of the layers in a heat exchanger 100 can maintain stringent quality standards required to avoid ruptures in pressure-boundary regions when implemented in a fast reactor, without further complicating manufacturing procedures. As discussed in greater detail elsewhere in the present disclosure, this arrangement of the layers is scalable such that multiple layers 110 and 120 may be stacked on one another prior to final bonding to produce varying sizes of heat exchangers, without requiring any substantial changes to the diffusion bonding process.

Further to the above, the first process fluid and the second process fluid may flow according to various flow patterns such as, for example, co-current, countercurrent, cross-current, or combinations thereof. Additionally, while the channels 116 and 126 are illustrated in FIG. 3 as being generally oriented in a common direction, other configurations are contemplated by the present disclosure. In some implementations, the first layer and the second layer may comprise linear channels that are rotationally offset with respect to each other and/or one or more of the channels may curve in various directions, such as the channels 46 depicted in FIGS. 1-2.

In various aspects, the first layer 110 and the second layer 120 are comprised of materials having high yield strength. In some aspects, the second layer 120 is comprised of a material that is compatible with supercritical water such as an austenitic stainless steel. In certain aspects, the second layer 120 is comprised of 316H series stainless steel which is ASME-code approved for diffusion bonded pressure boundary applications. Other austenitic stainless steels, such as alumina-forming austentic (AFA) alloys can also be used. While AFA and 316H stainless steels are similar in some respects, AFA alloys comprise a much lower chromium content and a much higher aluminum content than 316H. However, AFA alloys are not currently ASME-code approved for pressure boundary applications.

Further to the above, the first layer 110 may be comprised of a different material than that of the second layer 120, provided that different materials may still be diffusion bonded together. For example, when the first layer 110 is configured for a molten lead application, the sheet 112 and or plate 114 may be comprised of an alloy comprising aluminum. In some aspects, the first layer 110 comprises an AFA alloy. AFA alloys can provide the high corrosion and creep resistance typically associated with a 300 series stainless steel, such as 316H, in high temperature fast reactor environments, especially when in contact with molten lead which is corrosive and/or erosive to 300 series stainless steels. Since the first layer 110 does not act as a pressure boundary, a first layer 110 comprised of an AFA alloy in combination with a second layer 120 comprised of an ASME-code approved material can leverage qualities of non-codified materials in low pressure regions of the heat exchanger 100 while adhering to ASME-code and/or other equipment regulations in regions where pressurized fluid may exist. Thus, a heat exchanger 100 incorporating this configuration may be deployed prior to codification of alternative materials. Other configurations are contemplated by the present disclosure. For example, in some implementations where the first fluid is a molten salt, the first layer may be comprised of a nickel-based alloy. Accordingly, the heat exchanger 100 can be configured to provide a long working lifetime in various applications such lead fast reactors, sodium fast reactors, gas cooled reactors, and non-nuclear applications such as concentrated solar applications where high temperature and/or high temperature conditions are prevalent.

Alternatively, or additionally, to the above, other materials which are compatible diffusion bonding may be incorporated based on the intended application of the heat exchanger 100. For example, in some implementations, layers may comprise aluminum, Alumina Forming Austenitic steel, Aluminum Oxide, Ceramics, Copper, Duplex Stainless Steels, FeCrAl Alloys, Gold and other exotics, Glidcop™, Haynes™ Alloys, Inconel™ Alloys, Magnesium, Molybdenum, Nickel, Platinum, Silver, Steel, Super Austenitic Stainless Steel and/or Titanium.

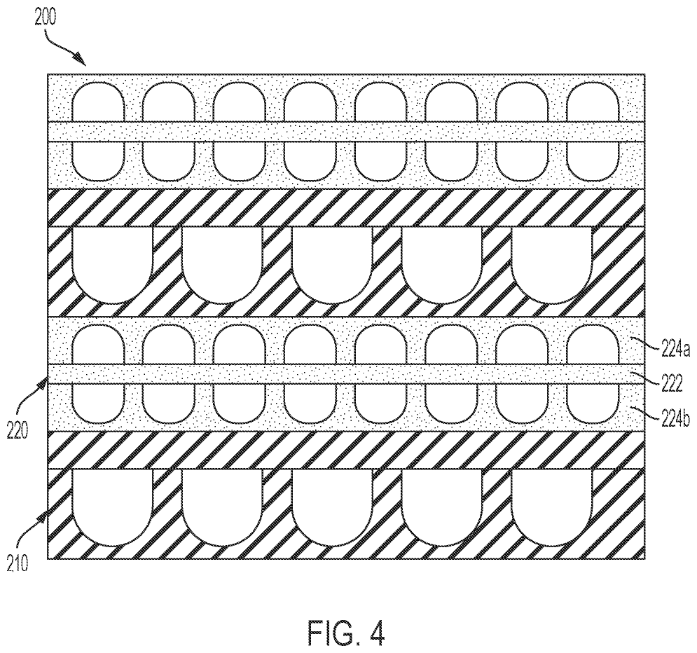

Now referring to FIG. 4, a cross sectional schematic representation of a heat exchanger 200 is provided, in accordance with at least one non-limiting embodiment of the present disclosure. The heat exchanger 200 is similar in many respects to other heat exchangers described elsewhere in the present disclosure, which are not repeated herein at the same level of detail for brevity. In various examples, the heat exchange 200 includes a first layer 210 for flowing a first process fluid and a second layer 220 for flowing a second process fluid. Each of the layers independent comprises a sheet and a plate defining flow channels therebetween. The first layer 210 and second layer 220, respectively, can be configured similarly to first layer 110 and second layer 120 as described hereinabove. Thus, the heat exchanger 200 can be configured with a combination of non-codified and codified materials to flow multiple process fluids requiring different material considerations, while adhering to ASME-code and/or other regulations. Accordingly, the heat exchanger 200 can address technical issues in fast reactors such as coolant specific material corrosion without being limited to employing codified materials, thereby providing the logistical flexibility to adhere to a deployment schedule.

Further to the above, as illustrated in FIG. 4, the second layer 220 can comprise two plates 224 such that a first plate 224a and a second plate 224b are sandwiched around a sheet 222. In this configuration, channels of adjacent layers may be positioned closer together than in other heat exchangers described hereinabove due to plates of adjacent layers being in contact with each other. Additionally, less material is required for a given flow of second process fluid through a heat exchanger 200 than in other heat exchangers described hereinabove. The inventors of the present disclosure have determined that the configuration of the heat exchanger 200 can provide a pressure boundary between different layers without sacrificing the strength required to maintain a reliable reactor operation. Thus, in some aspects, the second layer 220 can be configured provide an optimized heat transfer between fluids flowing through adjacent layers with a lower cost of materials while maintaining operating safety and reliability.

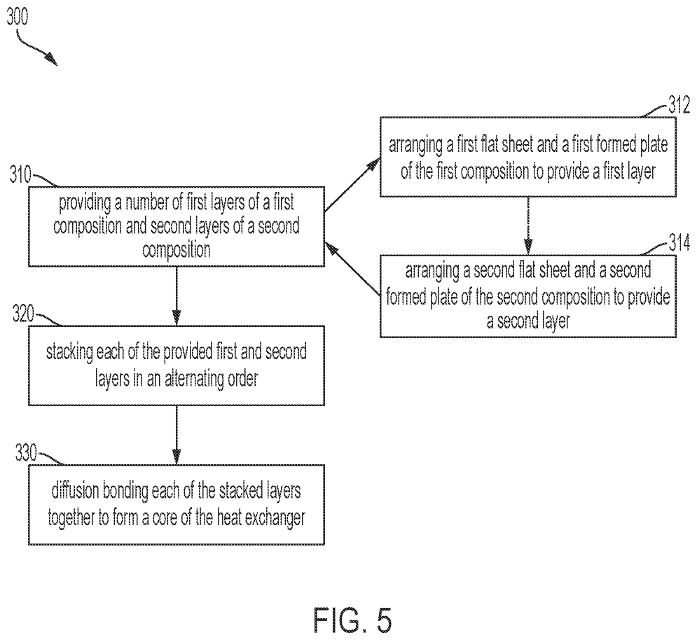

Now referring to FIG. 5, a method 300 for producing a heat exchanger is provided, in accordance with at least one non-limiting embodiment of the present disclosure. The method includes providing 310 a number of first layers of a first composition and second layers of a second composition, stacking 320 each of the provided first and second layers in an alternating order, and diffusion bonding 330 each of the stacked layers together to form a core of the heat exchanger. Other configurations of the method 300 are contemplated by the present disclosure. For example, in other implementations, the order of layers may be arranged in a unique non-repetitive pattern as desired, or a subassembly of layers, such as two second layers stacked on top of a first layer, may be repetitively stacked.

Providing 310 the number of first layers and second layers includes arranging a first flat sheet and a first formed plate of the first composition to provide 312 a first layer and arranging a second flat sheet and a second formed plate of the second composition to provide 314 a second layer. In various examples, providing 312 the first layer and providing 314 the second layer are executed repetitively such that multiples of each of the first layer and the second layer are provided and later stacked 320 so that any given first layer is sandwiched between two second layers and/or any given second layer is sandwiched between two first layers. In some examples, providing 314 the second layer includes arranging a second flat sheet between two second formed plates of the second composition. The first layers and second layers are similar in many respects to layers of heat exchangers 100 and 200 described hereinabove. Thus, the method 300 can produce heat exchangers which are able to address technical issues in fast reactors such as coolant specific material corrosion without being limited to employing codified materials. Additionally, providing 312 a first layer and/or providing 314 a second layer can include diffusion bonding flat sheets and formed plates of each layer to form diffusion bonded layers prior to the stacking 320 and in certain examples, may include inspecting and/or pressure testing the first layers and/or second layers prior to the stacking 320. Accordingly, the method 300 can be configured to produce heat exchangers with low defect rates while maintaining manufacturing simplicity.

Further to the above, the diffusion bonding 330 is executed as a single operation following the arrangement of any layers to be included in a core of the heat exchanger. Thus, the method 300 can facilitate manufacturing scalability by avoiding layer to layer welding and/or any other time-consuming joining operations between each layer, each of which may be necessitated by conventional manufacturing methods. Accordingly, the method 300 can provide economical and technical advantages over conventional methods of producing heat exchanger by providing a reduced operational complexity and/or quality control thereof.

Various aspects of the present disclosure include, but are not limited to, the aspects listed in the following numbered clauses.

Clause 1—A heat exchanger for a nuclear reactor, the heat exchanger comprising a first layer comprised of a first material, and a second layer comprised of a second material differing in composition from the first material. The first layer and the second layer are stacked on, and bonded to, each other in a core of the heat exchanger. The first layer is for flowing a first process fluid. The first layer comprises a first sheet and a first formed plate defining a number of first flow channels therebetween. The second layer is for flowing a second process fluid. The second layer comprises a second sheet and a second formed plate defining a number of second flow channels therebetween.

Clause 2—The heat exchanger of clause 1, wherein the first layer and the second layer are diffusion bonded to each other.

Clause 3—The heat exchanger of any one of clauses 1-2, wherein the second layer further comprises a third formed plate, wherein the second sheet is sandwiched between the second formed plate and the third formed plate.

Clause 4—The heat exchanger of any one of clauses 1-3, wherein the second layer is configured as a pressure bearing region.

Clause 5—The heat exchanger of any one of clauses 1-4, wherein the second process fluid comprises water.

Clause 6—The heat exchanger of clause 4, wherein the pressure bearing region is configured to enclose the second process fluid at a temperature, a pressure, or a combination thereof, greater than or equal to a critical point associated with the second process fluid.

Clause 7—The heat exchanger of any one of clauses 1-6, wherein the second process fluid is supercritical water.

Clause 8—The heat exchanger of any one of clauses 1-7, wherein the second material comprises stainless steel.

Clause 9—The heat exchanger of any one of clauses 1-8, wherein each of the first flow channels are configured as an ambient pressure region.

Clause 10—The heat exchanger of any one of clauses 1-9, wherein the first process fluid is incompatible with the second material.

Clause 11—The heat exchanger of any one of clauses 1-10, wherein the first process fluid is corrosive to the second material at operating conditions.

Clause 12—The heat exchanger of any one of clauses 1-11, wherein the first process fluid comprises a liquid metal, an ionic liquid, a molten metal, a molten salt, or any combination thereof.

Clause 13—The heat exchanger of any one of clauses 1-12, wherein the first process fluid comprises lead.

Clause 14—The heat exchanger of any one of clauses 1-13, wherein the first material comprises aluminum.

Clause 15—The heat exchanger of clause 14, wherein the first material is an alumina forming alloy.

Clause 16—The heat exchanger of any one of clauses 1-15, wherein the first material comprises nickel.

Clause 17—The heat exchanger of any one of clauses 1-16, wherein the first layer is a diffusion bonded first layer and the second layer is a diffusion bonded second layer. The diffusion bonded first layer comprises the first sheet diffusion bonded to the first formed plate. The diffusion bonded second layer comprises the second sheet diffusion bonded to the second formed plate. The diffusion bonded first layer and the diffusion bonded second layer are stacked on each other prior to being bonded to one another.

Clause 18—A heat exchanger for a nuclear reactor, the heat exchanger comprising a core. The core comprises first layers for flowing a lead based fluid and second layers for flowing a supercritical fluid. Each of the first layers comprises a first sheet and a first formed plate defining a number of first flow channels therebetween. Each of the first layers is comprised of a first material configured to be compatible with the lead based fluid. Each of the second layers comprises a second sheet and a second formed plate defining a number of second flow channels therebetween. Each of the second layers is comprised of a second material incompatible with the lead based fluid. The first layers and the second layers are stacked in an alternating arrangement and diffusion bonded to one another.

Clause 19—A method for producing a heat exchanger. The method comprises providing a number of first layers and second layers, stacking each of the provided first layers and second layers in an alternating order, and diffusion bonding the stacked layers together to form a core of the heat exchanger. Providing the number of first layers comprises arranging a first flat sheet and a first formed plate to provide a first layer, wherein the first formed plate and the first flat sheet define a number of first flow channels therebetween, and wherein the first flat sheet and the first formed plate are comprised of a first composition. Providing the number of second layers comprises arranging a second flat sheet and a second formed plate to provide a second layer, wherein the second formed plate and the second flat sheet define a number of second channels therebetween, wherein the second flat sheet and the second formed plate are comprised of a second composition.

Clause 20—The method of clause 19, further comprising, prior to stacking each of the provided first layers and second layers, diffusion bonding the arranged first flat sheet and first formed plate and diffusion bonding the arranged second flat sheet and second formed plate.

Various features and characteristics are described in this specification to provide an understanding of the composition, structure, production, function, and/or operation of the disclosure, which includes the disclosed methods and systems. It is understood that the various features and characteristics of the disclosure described in this specification can be combined in any suitable manner, regardless of whether such features and characteristics are expressly described in combination in this specification. The Inventors and the Applicant expressly intend such combinations of features and characteristics to be included within the scope of the disclosure described in this specification. As such, the claims can be amended to recite, in any combination, any features and characteristics expressly or inherently described in, or otherwise expressly or inherently supported by, this specification. Furthermore, the Applicant reserves the right to amend the claims to affirmatively disclaim features and characteristics that may be present in the prior art, even if those features and characteristics are not expressly described in this specification. Therefore, any such amendments will not add new matter to the specification or claims and will comply with the written description, sufficiency of description, and added matter requirements.

With respect to the appended claims, those skilled in the art will appreciate that recited operations therein may generally be performed in any order. Also, although various operational flows are presented in a sequence(s), it should be understood that the various operations may be performed in other orders than those that are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

The invention(s) described in this specification can comprise, consist of, or consist essentially of the various features and characteristics described in this specification. The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. Thus, a method or system that “comprises,” “has,” “includes,” or “contains” a feature or features and/or characteristics possesses the feature or those features and/or characteristics but is not limited to possessing only the feature or those features and/or characteristics. Likewise, an element of a composition, coating, or process that “comprises,” “has,” “includes,” or “contains” the feature or features and/or characteristics possesses the feature or those features and/or characteristics but is not limited to possessing only the feature or those features and/or characteristics and may possess additional features and/or characteristics.

The grammatical articles “a,” “an,” and “the,” as used in this specification, including the claims, are intended to include “at least one” or “one or more” unless otherwise indicated. Thus, the articles are used in this specification to refer to one or more than one (i.e., to “at least one”) of the grammatical objects of the article. By way of example, “a component” means one or more components and, thus, possibly more than one component is contemplated and can be employed or used in an implementation of the described compositions, coatings, and processes. Nevertheless, it is understood that use of the terms “at least one” or “one or more” in some instances, but not others, will not result in any interpretation where failure to use the terms limits objects of the grammatical articles “a,” “an,” and “the” to just one. Further, the use of a singular noun includes the plural, and the use of a plural noun includes the singular, unless the context of the usage requires otherwise.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Also, all ranges recited herein are inclusive of the end points of the recited ranges. For example, a range of “1 to 10” includes the end points 1 and 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

As used in this specification, particularly in connection with layers, the terms “on,” “onto,” “over,” and variants thereof (e.g., “applied over,” “formed over,” “deposited over,” “provided over,” “located over,” and the like) mean applied, formed, deposited, provided, or otherwise located over a surface of a substrate but not necessarily in contact with the surface of the substrate. For example, a layer “applied over” a substrate does not preclude the presence of another layer or other layers of the same or different composition located between the applied layer and the substrate. Likewise, a second layer “applied over” a first layer does not preclude the presence of another layer or other layers of the same or different composition located between the applied second layer and the applied first layer.

Whereas particular examples of this disclosure have been described above for purposes of illustration, it will be evident to those skilled in the art that numerous variations of the details of the present disclosure may be made without departing from the disclosure as defined in the appended claims.

What is claimed is:

1. A heat exchanger for a nuclear reactor, the heat exchanger comprising:
a first layer for flowing a first process fluid, the first layer comprising:
a first sheet; and
a first formed plate defining a number of first flow channels therebetween, wherein the first layer is comprised of a first material; and
a second layer for flowing a second process fluid, the second layer comprising:
a second sheet; and
a second formed plate defining a number of second flow channels therebetween, wherein the second layer is comprised of a second material differing in composition from the first material;
wherein the first layer and the second layer are stacked on each other in a core of the heat exchanger, and wherein the first layer and the second layer are bonded to each other.

2. The heat exchanger of claim 1, wherein the first layer and the second layer are diffusion bonded to each other.

3. The heat exchanger of claim 2, wherein the second layer further comprises a third formed plate, wherein the second sheet is sandwiched between the second formed plate and the third formed plate.

4. The heat exchanger of claim 1, wherein the second layer is configured as a pressure bearing region.

5. The heat exchanger of claim 4, wherein the second process fluid comprises water.

6. The heat exchanger of claim 4, wherein the pressure bearing region is configured to enclose the second process fluid at a temperature, a pressure, or a combination thereof, greater than or equal to a critical point associated with the second process fluid.

7. The heat exchanger of claim 6, wherein the second process fluid is supercritical water.

8. The heat exchanger of claim 4, wherein the second material comprises stainless steel.

9. The heat exchanger of claim 4, wherein each of the first flow channels are configured as an ambient pressure region.

10. The heat exchanger of claim 1, wherein the first process fluid is incompatible with the second material.

11. The heat exchanger of claim 10, wherein the first process fluid is corrosive to the second material at operating conditions.

12. The heat exchanger of claim 11, wherein the first process fluid comprises a liquid metal, an ionic liquid, a molten metal, a molten salt, or any combination thereof.

13. The heat exchanger of claim 10, wherein the first process fluid comprises lead.

14. The heat exchanger of claim 1, wherein the first material comprises aluminum.

15. The heat exchanger of claim 14, wherein the first material is an alumina forming alloy.

16. The heat exchanger of claim 10, wherein the first material comprises nickel.

17. The heat exchanger of claim 1, wherein:
the first layer is a diffusion bonded first layer, wherein comprising the first sheet diffusion bonded to the first formed plate;
the second layer is a diffusion bonded second layer comprising the second sheet diffusion bonded to the second formed plate; and
the diffusion bonded first layer and the diffusion bonded second layer are stacked on each other prior to being bonded to one another.

18. A heat exchanger for a nuclear reactor, the heat exchanger comprising a core, the core comprising:
first layers for flowing a lead based fluid, each of the first layers comprising a first sheet and a first formed plate defining a number of first flow channels therebetween, wherein each of the first layers is comprised of a first material configured to be compatible with the lead based fluid;
second layers for flowing a supercritical fluid, each of the second layers comprising a second sheet and a second formed plate defining a number of second flow channels therebetween, wherein each of the second layers is comprised of a second material incompatible with the lead based fluid; and
wherein the first layers and the second layers are stacked in an alternating arrangement, and wherein the stacked first layers and second layers are diffusion bonded to one another.

19. A method for producing a heat exchanger, the method comprising:
providing a number of first layers and second layers, wherein the providing comprises:
arranging a first flat sheet and a first formed plate to provide a first layer, wherein the first formed plate and the first flat sheet define a number of first flow channels therebetween, wherein the first flat sheet and the first formed plate are comprised of a first composition; and
arranging a second flat sheet and a second formed plate to provide a second layer, wherein the second formed plate and the second flat sheet define a number of second channels therebetween, wherein the second flat sheet and the second formed plate are comprised of a second composition;
stacking each of the provided first layers and second layers in an alternating order; and
diffusion bonding the stacked layers together to form a core of the heat exchanger.

20. The method of claim 19, further comprising, prior to stacking each of the provided first layers and second layers, diffusion bonding the arranged first flat sheet and first formed plate and diffusion bonding the arranged second flat sheet and second formed plate.
